(19) United States
(12) Patent Application Publication
(10) Pub. No.: US 2019/0184497 A1
(43) Pub. Date: Jun. 20, 2019

(54) LASER GMA HYBRID WELDING WITH TARGETED INDUCTIVE HEAT CONDUCTION

(71) Applicant: STAHLKONTOR GMBH + CO. KG, Hagen (DE)

(72) Inventors: Heiko DRAWE, Hagen (DE); Roman LITSCHMANN, Hagen (DE)

(21) Appl. No.: 16/321,868

(22) PCT Filed: Jul. 14, 2017
(86) PCT No.: PCT/EP2017/067863

§ 371 Date: Jan. 30, 2019

(30) Foreign Application Priority Data
Aug. 17, 2016 (DE) 10 2016 115 239.0

(51) Int. Cl. B23K 26/348; B23K 9/16; B23K 26/60

(52) U.S. Cl. CPC B23K 26/348; B23K 26/60; B23K 9/164

(57) ABSTRACT

The invention relates to a method for laser beam GMA hybrid welding for undetachably joining two or more components made of a high-strength steel, wherein the region around the joining point is inductively heated to 100° C. to 300° C., preferably a method for defense use, wherein the region around the joining is heated up to 150° C. to a maximum of 200° C.

The invention relates to a laser GMA hybrid welding method for fixing together two or more components of high-strength steel.

A multiplicity of joining methods exist for fixing together two components of a metallic material.

One of the joining methods is a laser-beam welding method in which the joint is melted by a laser beam directed thereonto and is subsequently solidified.

Apart from the laser-beam welding method, there is the gas metal arc welding method that can be universally used and that using modern welding-current sources and wire advancing units can be readily managed. the gas metal arc welding method (also referred to as GMA welding method or MIG or MAG method, respectively) can also be very readily carried out by fully mechanized welding.

Finally, it is known for the two aforementioned methods to be combined in a hybrid method, specifically a laser GMA hybrid welding method. On account thereof, further improvements both in terms of the welding speed as well as in the loading capability of the joint can in particular be achieved in the case of fully mechanized welding.

However, the loading capability has its limits in the case of extreme stresses. Such extreme stresses are, for example, the shelling of components of ballistic steels, for example vehicle components that are composed of at least two parts and that by virtue of their shaping cannot be integrally configured but are composed of two joined parts. This joint, typically a weld seam across a comparatively long extent, in the case of such a high stress as arises, for example, by shelling or an explosion, represents an unacceptable weak point.

This weak point in the case of the high-strength steels used (for example fine-grained steels) results in that on account of the use of the laser GMA hybrid welding method a high speed is set, on account of which rapid cooling of the joint arises after the welding method has been carried out, and the material of the two components to be joined in this region becomes brittle on account thereof. The joint, on account thereof, cannot withstand the required stresses.

In the use of components of ballistic steels it is moreover necessary for alloying elements to be added to the steels in order for the predefined strength values to be achieved in the production thereof, so that the predefined strength values of the steel, for example of the steel sheet, are achieved. This however is associated with the disadvantage that at least one of the alloying elements, or else combinations thereof, have the effect that the high-strength steel in the joining procedure (the carrying out of the welding process) in the so-called heat-affected zone (HAZ) that is situated directly beside the joint or the joining seam, respectively, tends to form very hard microstructure components. This hardening in the HAZ is more intense the faster the region directly beside the joint cools, as has already been described. However, the cooling disadvantageously leads to the cooling all the more rapidly in relation to the environment thereof (neighboring cold steel region). This behavior is yet again amplified by the use of the joining method by lasers, since for this method a very high temperature gradient is present as compared to conventional welding. On account thereof, hardened and brittle joining regions that tend to form cracks under extreme stress are created in a disadvantageous manner that in the later use is critical in terms of safety.

A laser GMA hybrid welding method for joining civil components (such as, for example, a tubular steel tower) of a wind power installation of high-strength steel is known from Lando, Rabi (et al): Laserstrahl-MSG-Hybridschweiβen von Feinkornbaustählen für den Einsatz im Stahlbau [Laser GMA hybrid welding of fine-grained construction steels for the use in steel construction] (in Stahlbau, Volume 84, 2015, Edition 12, pages 1016 to 1022, ISSN 0038-9145), in which a region about a joint is inductively heated to a temperature of 190 degrees Celsius. Such civil components such as, for example, wind power installations, are however not exposed to any extreme situations such as, for example, shelling from the outside or explosions that are initiated in a targeted manner. Therefore, it is also entirely sufficient in the case of such constructions for a high-strength steel that has a hardness of at most 450 HV (approximately 420 HBW) and a yield strength of at most 690 MPa (fine-grained construction steel of the S690QL quality) to be used for the components that are to be joined.

From Bach, Fr.-W. (et al): Verbessertes Umformverhalten durch serielle induktive Nachwarmung von Laserstrahlschweiβnähten [Improved forming behavior by serial inductive post-heating of laser beam weld seams] (in: Materialwissenschaft and Werkstofftechnik, Volume 33, 2002, Edition 7, pages 410 to 414, ISSN 0049-8688) it is known for laser-beam welding having inductive post-heating of the laser beam weld seams to be used so as to meet increased requirements for the lightweight construction of motor vehicles in the case of increasing rigidities and increasing safety requirements. To this end, so-called tailort blanks are used in the load-bearing structure, wherein the tailort blanks are however very thin (typically less than 1 mm), since it is known in the automotive sector for material to be saved even in the safety-critical region so as to implement the weight of a vehicle, this being of particular importance here. In this prior art, a material H340 having a maximum sheet-metal thickness of one millimeter is therefore used so as to form therefrom two components that by means of laser-beam welding are to be non-releasably connected to one another. The finished component formed therefrom (initially composing of two individual components) has a yield strength of at most 420 MPa at a microhardness of at most 300 HV. Components formed in such a manner meet the requirements in terms of the lightweight construction in motor vehicles, but not safety-critical safety requirements under shelling or when such vehicles are exposed to explosions.

The invention is therefore based on the object of improving a laser GMA hybrid welding method for fixing together at least two components of ballistic steel (steel having ballistic properties for the primary personal protection in the case of military and/or civil applications) such that the at least two components also withstand maximum stresses, in particular shelling or explosions stresses.

This object is achieved in that the region at the joint is inductively heated to 150° C. to 300° C.

The inductive heating (also referred to as pre-heating, that is to say the external supply of heat in the pre-process or the post-process during or after the welding process) has the advantage that the two components to be joined are indeed not heated in their entirety (this nevertheless would be conceivable, depending on the geometric extent of the components), but that such a region at the joint is heated such that the disadvantageous influence of the “cold regions” of the joined components at the joint described is substantially reduced or completely eliminated. This means that the regions at the joint, in particular about the joining seam, are heated such that it is effectively avoided that the region of the joint does not cool too rapidly after the laser GMA hybrid welding method has been carried out successfully. On account thereof, the formation of hardened, brittle regions that are thus susceptible to cracks is effectively avoided.

The heating to a range of 100° C. to 300° C. has the advantage of the effect described, specifically that the regions of the components to be joined at the joint cool more slowly the more they are heated. Attention has to be paid herein that the heating is not carried out at temperatures that have an influence on a modification of the microstructure of the high-strength fine-grained construction steels. The heating herein not only depends on the high-strength steel used, but also on the geometric extent (area) of the components to be joined and the material thickness thereof.

A particularly important range of a heating temperature is the range from 150° C. to 200° C. since the inductive heating in the temperature range can be carried out rapidly and at a justifiable cost input, and the avoidance of regions susceptible to cracks is simultaneously avoided. This is carried out imperatively and advantageously for the treatment of components of ballistic steels (in particular for the application in defense sectors), since the mechanical-technological properties of the joined components that form an armored component on account thereof is surprisingly significantly enhanced in the region of the joint and about the latter.

In order for the requirements in terms of protection of devices that are formed using the joined component to be adhered to, the use of high-strength steels, in particular ballistic steels that besides the processing thereof also have specific material properties is further required.

It has been demonstrated that the high-strength steel of which the components are composed have a yield strength of at least 690 MPa and a hardness of at least 420 HBW in order for the desired properties of the later completed device that is composed of the at least two non-releasably joined components to be achieved. This means that high-strength steels having a yield strength of at least 690 MPa and a hardness of at least 420 HBW are used according to the invention and are non-releasably joined to one another by the laser GMA hybrid welding method. The inductive heating of the region at the joint to 100 degrees Celsius to 300 degrees Celsius in conjunction with the material properties has the effect of an extreme strength of the fabricated device in which the two or more components are used. the components, by virtue of the combination of material properties and joining parameters, withstand particularly well above all in the case of shelling of components such as, for example, the vehicle components mentioned, or explosions to which the components are exposed.

In a refinement of the invention the heating is carried out in a targeted manner before and/or after carrying out the welding method. It is ensured in all three cases that the components to be joined have such energy using which the slow cooling effect after carrying out the welding is achieved. The heating to the predefined temperature range before or after, respectively, carrying out the welding process is particularly advantageous so as to avoid that the high-strength steel after the completion of the welding process tends to form very hard microstructure components in the heat affected zone.

In a refinement of the invention the welding method is carried out at a defined speed, depending on the material thickness of the components to be joined. On account thereof, it is not only advantageously possible to weld very rapidly and thus at a significantly higher welding speed as compared to conventional welding along a joining seam, but on account of the inductive heating to also achieve the required mechanical-technological properties of the joined components, the properties being adapted in an optimal manner to the material thickness. Two objectives are thus advantageously pursued and implemented: a high welding speed and a high loading capability under extreme stresses as compared to partially mechanized and/or fully mechanized welding processes.

In a refinement of the invention an induction coil for the inductive heating is moved in front of and/or behind the laser beam at the defined, preferably identical, speed of the laser beam. The installation for the laser GMA hybrid welding method can therefore thus be advantageously combined with the installation for heating (in general terms the induction coil). This means that the region to be heated leads and/or trails the welding installation such that, on account thereof, the required heating for avoiding the excessively rapid cooling is always carried out after carrying out the welding method. The installations for welding and for heating can thus be coupled to one another in a simple manner.

The heating of the joint has moreover also the advantage that, above all, comparatively long weld seams can be implemented. To date, using the known welding methods, it has not been possible to weld in one pass comparatively long weld seams that extend in particular across the total length of the components to be joined. Welding has always had to be carried out in portions (for example by the back-step method), so as to minimize an undesirable distortion in the components. In summary, the advantages thus lie in the optimal setting of the mechanical-technological properties of the joint region, the business-management consideration in terms of the higher welding speed, and the almost distortion-free welding of oversized components.

The application of the afore-described laser GMA hybrid welding method using inductive heat conduction is very particularly advantageous for defense-sector use, since components of high-strength ballistic steel are used herein and in use are subjected to maximum stresses, in particular by shelling or explosion, respectively. The components to be joined can be used in stationary or mobile installations such as, for example, armored vehicles, or the like.

Examples of groups of high-strength steels for the defense-sector use to be mentioned (without implying limitations) are functional groups having material properties up to the quality Z according to TL 2350-0000, as are such according to the standards: CEN ISO/TR 15608, table 1, group 3.

In a refinement of the invention the high-strength steel has a yield strength of at least 800 MPa and a hardness of at least 450 HBW. This means that high-strength steels having the material properties are used so as to be non-releasably joined by the mentioned method. The protective effects by virtue of the improved, that is to say enhanced, material properties are yet again increased on account thereof.

A particularly preferred selection of the high-strength steels to be applied can be seen in that the high-strength steel of each one of the components has a yield strength in a range from at least 1000 MPa to at most 1750 MPa, and a hardness in a range from at least 475 HBW to at most 550 HBW. The inductive heating before and/or after the joining, by virtue of the use of the high-strength steels having the material properties, can be adapted in an optimal manner to the components that are to be joined. On account of the use of the steels having the mentioned material properties (yield strength and hardness), devices that have such joined components and meet particularly high requirements can be implemented.

Alternatively thereto, a device of high-strength steels according to the invention can be formed when the high-strength steel has a yield strength in a range from at least 1100 MPa to at most 1650 MPa, and a hardness in a range from at least 420 HBW to at most 530 HBW. An alternative material that can be used for forming the device is thus likewise available for achieving the required stabilities of devices under shelling or when exposed to explosions.

In a refinement of the invention it is provided that the at least two components to be joined have a material thickness of at least 3 millimeters (three millimeters, 3 mm). It is guaranteed on account of the minimum material thickness that devices such as, for example, vehicle components for civil or military applications, are dimensioned so as to be sufficiently strong when such devices such as, for example, vehicles, are being shelled or are exposed to explosions. The material properties provided according to the invention of the high-strength steels of which the components are composed, the non-releasable joining of the components, and the minimum material thickness overall lead to an advantageous universal protection of the device that also meets maximum safety requirements.

The yield strength Rₑ is a material key indicator and refers to the tension up to which a material under uni-axial and torque-free tensile stress does not display any permanent plastic deformation. This herein is a yield point. In the event of the value being undershot, the material after de-stressing returns elastically to the original shape thereof, while in the event of the value being exceeded, a shape variation remains, this thus being an elongation in the case of a specimen. Depending on the material behavior, either the yield strength or the yield point is used for establishing the elasticity limit of the material. The yield strength is simple to determine by established and standardized tensile tests and in technical terms is of maximum significance. the yield strength is indicated by the units “MPa” (Megapascal) or “N/mm²” (Newton per square millimeter).

Hardness is a measure of the mechanical resistance by a material to the mechanical indentation by another body. Depending on the type of the effect, different types of hardness are differentiated. Hardness is thus not only the resistance to harder bodies but also to softer bodies and bodies of identical hardness. Hardness is indicated by the unit “HB” (Brinell hardness) or “HBW” (Brinell hardness, W referring to the material of the testing ball indentor, i.e. tungsten carbide hard metal), respectively, and is determined according to established standardized measuring methods.

Respective conversion tables have been available for a long time in order for hardness indications by the unit “HB” or “HBW”, respectively, to be converted to the unit “HV” (Vickers hardness) or vice versa.

1. A laser GMA hybrid welding method for fixing together two or more components of high-strength steel, the method comprising the steps of:
inductively heating the region at the joint to 100° C. to 300° C., the high-strength steel having a yield strength of at least 690 MPa and a hardness of at least 420 HBW.

2. The method for according to claim 1, wherein the heating at the joint is carried out up to 150° C. to at most 200° C.

3. The method according to claim 1 wherein, for defense-sector use, the heating is carried out in a targeted manner before and/or after carrying out the welding method.

4. The method according to claim 1, wherein the welding method is carried out at a defined speed depending on the material thickness of the components to be joined.

5. The method according to claim 4, wherein the heating of the region at the joint is effected inductively for a predetermined time.

6. The method according to claim 5, further comprising the step of:
moving an induction coil for the inductive heating in front of and/or behind the laser beam at the defined speed of the laser beam.

7. The method according to claim 1, wherein the high-strength steel has a yield strength of at least 800 MPa and a hardness of at least 450 HBW.

8. The method claim 1, wherein the high-strength steel has a yield strength in a range from at least 1000 MPa to at most 1750 MPa, and a hardness in a range from at least 475 HBW to at most 550 HBW.

9. The method according to claim 1, wherein the high-strength steel has a yield strength in a range from at least 1100 MPa to at most 1650 MPa, and a hardness in a range from at least 420 HBW to at most 530 HBW.

10. The method according to claim 1, wherein the at least two components to be joined have a material thickness of at least 3 millimeters.
